(19) United States
(12) Patent Application Publication
(10) Pub. No.: US 2004/0101118 A1
(43) Pub. Date: May 27, 2004

(54) Caller identification data management

(76) Inventor: Steven Powell, Memphis, TN (US)

Correspondence Address: Ortiz &Lopez, PLLC, Patent Attorneys, P.O. Box 4484, Albuquerque, NM, 87196-4484, US

(21) Appl. No.: 10/656,520

(22) Filed: Sep. 5, 2003

Related U.S. Application Data
(60) Provisional application No. 60/408,827, filed on Sep. 6, 2002.

(51) Int. Cl. H04M 1/56; H04M 3/42; H04M 15/06

(52) U.S. Cl. 379/142.1; 379/142.17; 455/415

(57) ABSTRACT

A caller identification data management apparatus is disclosed herein. A caller identification data management apparatus can include a data management unit having a plurality of input buttons thereon, which permit a user to input commands to said data management unit, wherein said data management unit is connectable to a telephone, and a caller identification module associated with said data management unit, wherein the caller identification module generates caller identification data based on caller identification data contained within a ring pattern of an incoming telephone call. Such an apparatus also includes a printer unit integrated with said data management unit, wherein said printer unit prints caller identification data generated by said caller identification module. Additionally, such an apparatus can be configured to include a display screen for displaying caller identification data generated by said caller identification module for a user.

### CROSS-REFERENCE TO RELATED APPLICATION

This patent application claims priority under 35 U.S.C. § 119(e) to provisional patent application Serial No. 60/408,827 filed Sep. 6, 2002, the disclosure of which is incorporated herein by reference.

### TECHNICAL FIELD

Embodiments are generally related to communication devices and services. Embodiments are also related to devices and services employing cellular identification (ID) information to process incoming calls. Embodiments are also related to printing devices. Embodiments are additionally related to electronic hand held devices, such as personal digital assistant (PDA) devices and cellular telephones.

### BACKGROUND OF THE INVENTION

Communications devices, including telephones, facsimile machines, answering machines, paging devices, and the like, have become an integral part of both business and domestic environments. While offering tremendous convenience and facilitating interpersonal contact and information exchange, these devices may also serve as a source of aggravation and annoyance. Undesired telephone calls from telemarketers, for example, have become a constant source of frustration for the average individual, invading his or her privacy and time.

A variety of caller identification, call screening and call blocking devices and/or services are offered or have been contemplated. Such devices, including services thereof, are generally referred to by the term “caller ID,” which is well known in the art. Such devices and services typically display calling party identification (i.e., caller ID) information while letting the call ring through. Incoming calls thus continue to disturb the receiving party and disrupt their activity. Existing devices and service also typically lack the capacity for customization, so that different calling parties may automatically be handled differently.

Telephone instruments with caller ID capabilities have been in use for some time. When such instruments receive a telephone call, they also receive data representing the telephone number of the calling telephone and the name of the person owning the calling telephone. The telephone number and/or name may be displayed when the telephone call is received. The subscriber can then know the identity of the person making the call, and prepare for the conversation or not answer the call at all.

An example of a caller ID system is disclosed in U.S. Pat. No. 5,734,706, “Caller Identification and Data Retrieval System,” which issued on Mar. 31, 1998 to Windsor et al and is incorporated herein by reference. U.S. Pat. No. 5,734,706 describes a method and apparatus for identification through telephony signaling, including formatting an incoming or outgoing basic telephone signal, and storing or retrieving information pertaining thereto. A conversion device is connected on the tip and ring side of a telephonic device. The caller identification information provided by the telephone company on incoming calls or the dual tone multiple frequency signals on outgoing calls is formatted into ASCII character text, which is used as an index to a relational database. Information relating to the formatting signal is read and/or written to the database, and displayed on a display unit or printed, while the call is in progress.

Another example of a caller ID system is disclosed in U.S. Pat. No. 5,970,128, “Telephone Device for Caller Identification,” which issued on Oct. 19, 1999 to Sang-Woo Kim and which is incorporated herein by reference. U.S. Pat. No. 5,970,128 describes a caller ID telephone device, which can identify the caller of a telephone call in either the on-hook or off-hook states. The caller ID telephone device includes a circuit for detecting a Customer Premises Equipment (CPE) alerting signal, a circuit for generating an acknowledgment signal when the CPE alerting signal is detected, a circuit for demodulating the modulated CID data stream, and a circuit for analyzing the data stream and output parallel data.

A further example of a caller ID system is disclosed in U.S. Pat. No. 6,178,232, “Method and System for Providing Enhanced Caller Identification,” which issued on Jan. 23, 2001 to Latter et al and is incorporated herein by reference. U.S. Pat. No. 6,178,232 describes a method and system that provides enhanced caller identification information to a called party. The system determines whether or not standard caller identification information associated with a calling party can be provided to the called party. The system determines whether the standard caller identification information is unavailable, incomplete or has been blocked. When the system determines that the standard caller identification information cannot be provided, the system transmits a request for audible caller identification information to the calling party. If the calling party provides the requested audible caller identification information, the audible caller identification information is transmitted to the called party. The called party is thus provided with information about the calling party that can assist the called party in deciding whether or not to answer the call.

One of the major problems associated with current caller ID systems, methods and devices thereof is that the local telephone provider or telephone company generally provides users with caller ID options. Users are thus dependent upon their provider for caller ID services and are unable to print the display numbers, dates, time of call, and so forth. Based on the foregoing, the present inventor has determined that users are therefore unable to perform a variety of functions from an independent system that is external to the actual telephone or receiving unit itself. For example, current caller ID devices do not permit users to electronically print caller ID information instantly at the press of a button.

Users typically are provided with a caller ID function by their phone company or telecommunications provider, and thus devices external to their phone must coordinate with the user's specific subscription plan and caller ID services thereof. Current caller ID devices also do not permit users to automatically and individually select a telephone number displayed on a display screen for dialing thereof. Most caller ID devices display the caller ID information on a display screen on an individual basis. A compiled list of calling ID information (i.e., names/telephone numbers, time called, etc) is typically unavailable.

Current caller ID devices also generally do not permit users to print caller ID information to a label with an adhesive backing. Such systems and methods also do not permit users to print the saved name and numbers from their cellular telephone. In addition, current caller ID devices do not permit users to block or un-block selected telephone numbers, all private telephone numbers, unavailable telephone numbers, out-of-area telephone numbers, and so forth, from a device external to the telephone or located at the customer's premises. Again, users are at the mercy of their telephone provider for such features. In addition, current caller ID devices do not permit users to manually select or de-select illumination of display of the caller ID. In essence, users are unable to perform many desired caller ID features/options utilizing a device external to and independent from the telephone set.

Current caller ID devices also do not permit the caller ID unit to be attached or connected to a personal computer, a PDA (Personal Digital Assistant), and/or or an electronic phonebook device and populate (via software) such devices with telephone numbers, names, dates, and times into a database or spreadsheet or other similar software programs processed on such devices. For many years, users of caller ID devices have been limited to a few caller ID and telephonic options, usually consisting of less than five options and could not print out alpha and text data. Consumers were forced to purchase standard caller ID units that offered the user the ability to know who is calling before answering the phone and receiving the call, but were not able to print out caller ID information from a home communications command center, or to program additional options with respect to telephone calls coming into their home, small business or private office.

The present inventor has recognized that current caller ID devices do not permit caller ID devices to communicate with mobile devices, such as, mobile (e.g. digital cellular) telephones and wireless PDA devices. The present inventor has also recognized that a need exists for a caller ID device with far greater memory capabilities than is presently offered. For example, current caller ID devices do not communicate with personal computers. The present inventor believes that if such devices could communicate with a personal computer or other computing devices, such as laptop computers or PDA devices, a large number of telephone numbers (e.g., 300), including associated names, dates, and times (i.e., blocked or unblocked telephone calls) could be stored on a personal computer system, PDA device and mobile phone. Finally, the present inventor has concluded that current caller ID devices do not permit access to two or more line printers from one external device.

The present inventor thus believes that if such capabilities could be achieved, users would no longer be forced to rely solely on their telephone providers for enhanced telecommunications services. The invention described herein thus solves shortfalls associated with the prior art through the use of unique caller ID data management systems and methods, which are further disclosed herein.

### BRIEF SUMMARY OF THE INVENTION

The following summary of the invention is provided to facilitate an understanding of some of the innovative features unique to the invention, and is not intended to be a full description. A full appreciation of the various aspects of the invention can be gained by taking the entire specification, claims, drawings, and abstract as a whole.

It is therefore one aspect of the present invention to provide an improved caller ID apparatus.

It is another aspect of the present invention to provide an improved caller ID printer apparatus.

It is a further aspect of the present invention to provide a caller ID data management method and apparatus.

It is a further aspect of the present invention to provide wired and/or wireless data synchronization between a caller ID data management method and a mobile device.

The above and other aspects can be achieved as is now described. A caller identification data management apparatus and method are disclosed herein. A caller identification data management apparatus can include a data management unit having a plurality of input buttons thereon, which permit a user to input commands to said data management unit, wherein said data management unit is connectable to a telephone, and a caller identification module associated with said data management unit, wherein the caller identification module generates caller identification data based on caller identification data contained within a ring pattern of an incoming telephone call. Such an apparatus can also include a printer unit integrated with said data management unit, wherein said printer unit can print caller identification data generated by said caller identification module. Such an apparatus can also be configured to include a display screen for displaying caller identification data generated by said caller identification module for a user. Additionally, such an apparatus can include wired and/or wireless means for communicating with mobile devices, such as PDAs, mobile phones and laptop computers.

### BRIEF DESCRIPTION OF THE DRAWINGS

The accompanying figures, in which like reference numerals refer to identical or functionally-similar elements throughout the separate views and which are incorporated in and form part of the specification, further illustrate the present invention and, together with the detailed description of the invention, serve to explain the principles of the present invention.

FIG. 1 illustrates a diagram of a print caller ID apparatus, in accordance with a preferred embodiment of the present invention;

FIG. 2 depicts a diagram of a print caller ID apparatus, in accordance with an alternative embodiment of the present invention;

FIG. 3 illustrates a diagram of a print caller ID apparatus, in accordance with an alternative embodiment of the present invention; and

FIG. 4 depicts a high-level system diagram for implementing a print caller ID apparatus, in accordance with a preferred embodiment of the present invention.

### DETAILED DESCRIPTION OF THE INVENTION

The particular values and configurations discussed in these non-limiting examples can be varied and are cited merely to illustrate an embodiment of the present invention and are not intended to limit the scope of the invention.

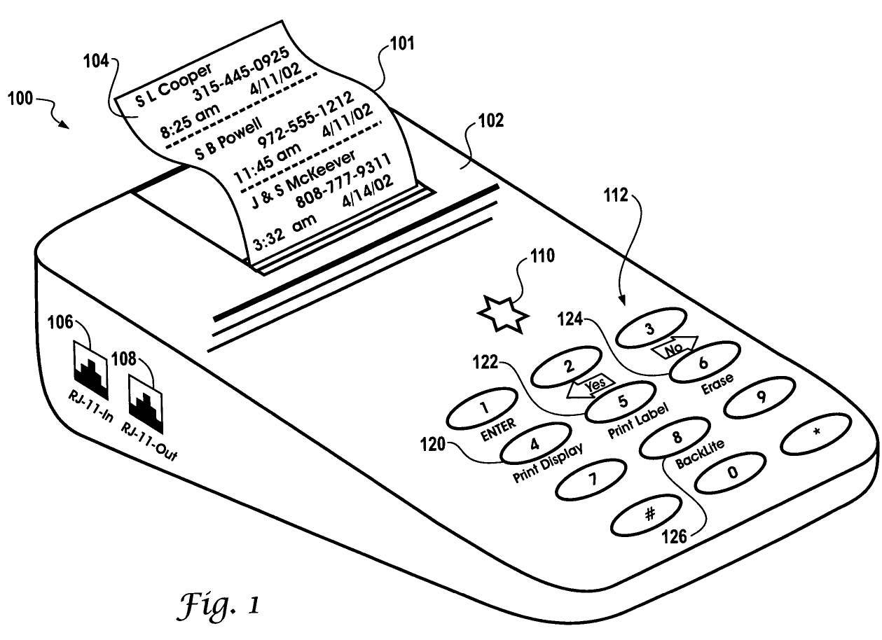

FIG. 1 illustrates a diagram 100 of a print caller ID apparatus 102, in accordance with a preferred embodiment of the present invention. Apparatus 102 includes a plurality of input buttons 112 and a printer unit 101, which can print caller ID data on printer paper 104. Data from a phone line that subscribes to a caller ID service from a telephone provider or telephone company can be input to apparatus 102 via a RJ11 phone jack. Note that apparatus 102 can include an RJ11 input 106 and an RJ11 output 108.

Printer unit 101 can print immediately, via buffer, the data from the telephone company call-waiting signal. Apparatus 102 can also be configured to include message light 110, which can be for example, a red neon light that flashes to indicate that a message is waiting (e.g., voice mail) and/or that caller ID data is available. Thus, apparatus 102 functions as a communication command center for a user, which combines all of the necessary features that user could possibly need in a printed form.

Apparatus 102 provides a number of functions, including Print Direct, Dial Display, Print Display, Print Label, and Print Cellular functionalities. Print Direct is a function that permits caller ID data to be printed to printer paper 104. A user utilizing button 120 can initiate the Print Direct function. Dial Display is a function that permits a selected phone number displayed on an LCD screen to be automatically printed. Print Display is a function that permits a print out of displayed caller ID data to printer unit 101. When a user presses button 120, the information displayed on a caller ID display screen can be printed on printer paper 104 via printer unit 104. Print Label permits information displayed on the LCD display screen to be printed as labels to special label paper.

A user utilizing button 122 can initiate the Print Label function. For example, the Print Label function can permit individual names, telephone numbers and/or address information to be printed to individual labels. Finally, Print Cellular is a function that provides cellular input circuitry for printing cellular addresses and telephone numbers. Thus, the Print Cellular function permits cellular telephone caller ID data to print out, via a cable adapter, from the cellular names and numbers to printer paper 104 by answering a series of prompts and pressing a print cellular button (i.e. one of the input buttons 112).

Input buttons 112 provide user input for the aforementioned functionalities. Apparatus 102 can be configured to accept ASCII data (e.g., laser, dot impact, LED, thermal and/or any other print readable data). Apparatus 102 can include a display (not illustrated in FIG. 1) that illuminates ASCII characters (e.g., black and white, plasma, rear projection, CRT, LED, LCD, etc.) and/or a device or module that displays an electronic image, alphanumeric text and/or ASCII text. All of the aforementioned functions/services are thus contained in apparatus 102 (i.e., a command box device) with input connectivity, such as RJ11 input 106 (i.e., or RJ45) and RJ11 output 108 (i.e., or RJ45), and printer functionality thereof.

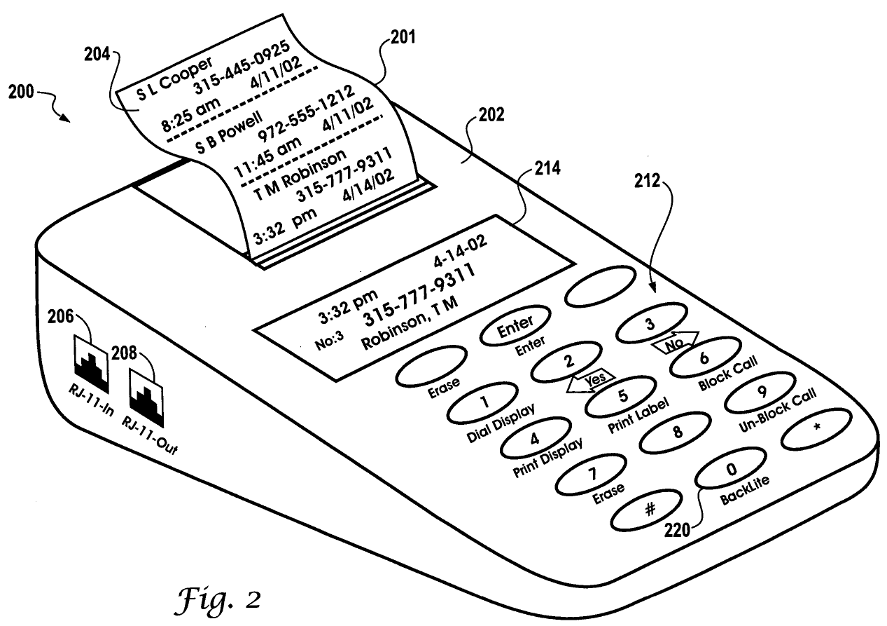

FIG. 2 depicts a diagram 200 of a print caller ID apparatus 202, in accordance with an alternative embodiment of the present invention. Apparatus 202 is analogous to apparatus 102 of FIG. 1, but contains additional features and functionalities. Apparatus 102 includes a plurality of input buttons 212 and a printer unit 201, which can print caller ID data on printer paper 204. Data from a telephone line that subscribes to a caller ID service from a telephone provider or telephone company can be input to apparatus 202 via a RJ11 phone jack. Note that apparatus 202 can include an RJ11 input 206 and an RJ11 output 208. Printer unit 201 can print immediately, via buffer, the data from the telephone company call-waiting signal. Apparatus 202 can also be configured to include a display screen 214.

Apparatus 202 can include the functionalities and services associated with apparatus 101 and additional functionalities and services. For example, apparatus 202 can feature Block Number, Unblock Number, Remove Number, Backlight, Lock Dial Out, and Name Display functionalities. Block Number is a functionality that permits a user to select a displayed telephone number to be blocked from their telephone systems. Thus, the number is blocked from a device, such as apparatus 202, that is external to the telephone service provided by the telephone company or telephone provider.

Unblock Number is a functionality that permits particular telephone numbers to proceed with ringing right through to the recipient. Remove Number is a functionality that deletes particular telephone numbers from memory. Backlight is a functionality that illuminates display screen 214 for ease of viewing. An input button such as button 220 can provide the Backlight functionality, for example. Lock Dial Out is a functionality that disables dialing out from a telephone attached to and/or in communication with device 202, except for particularly important telephone numbers such as, for example, 911. Name Display is a functionality that permits a business or family name to be customized for display via display screen 214 while in a standby mode.

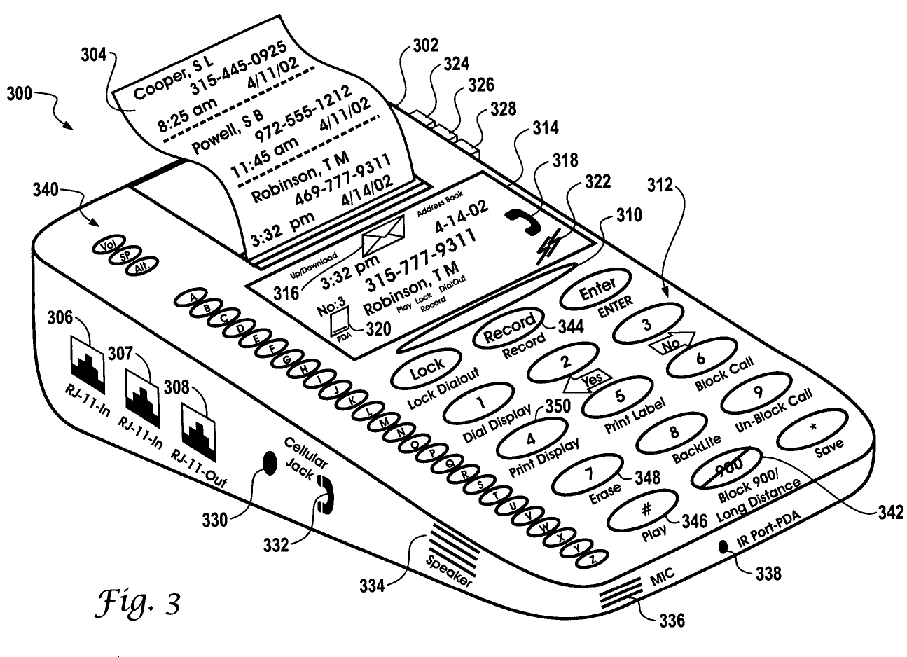

FIG. 3 illustrates a diagram 300 of a print caller ID apparatus 302, in accordance with an alternative embodiment of the present invention. Apparatus 302 is analogous to apparatus 102 of FIG. 1 and apparatus 202 of FIG. 2, but contains additional features and functionalities. Apparatus 302 includes a plurality of input buttons 312 and a printer unit 301, which can print caller ID data on printer paper 304. Data from a telephone line that subscribes to a caller ID service from a telephone provider or telephone company can be input to apparatus 302 via a RJ11 phone jack.

Note that apparatus 302 also includes two RJ11 inputs 306 and 307, and an RJ11 output 308. Printer unit 301 can print immediately, via buffer, the data from the telephone company call-waiting signal. Apparatus 302 can also be configured to include a display screen 314, control buttons 340 and a plurality of alphabetically arranged buttons A to Z. Control buttons 340 include a VOL, SP and ALT buttons. By pressing button 350 of apparatus 302, a user can print caller ID data displayed on display screen 314. Such information can be printed on printer paper 304 via printer unit 301 of apparatus 302.

Display screen 314 can display varying icons, such as, for example a PDA icon 320, which indicates that apparatus 302 is in communication with a PDA device. Other icons that can be displayed via display screen 314 include an envelope icon 316, which indicates that a message (i.e., voice mail) is ready for playback. Icon 322, which is arranged in shape of a lightning bolt, indicates that apparatus 302 is connected to an A/C adapter, which provides A/C power to apparatus 302. Such an A/C adapter can be connected to apparatus 302 via an A/C outlet 324. Icon 314, which is also displayable via display screen 314, can indicate that apparatus 302 is connected to and/or in communication with the user's telephone. Apparatus 302 can also be configured with voicemail functionality and can include message light 310, which can be for example, a blue neon light that flashes to indicate that a message is waiting (e.g., voice mail) and/or that caller ID data is available.

Apparatus 302 thus can include, in addition to the functionalities of apparatus 102 and 202: a caller ID phonebook, an optional emergency or 911 dialing feature, a wireless print system, a memory/storage unit, a 900 telephone number blocking capability, and long distance code capabilities. Additionally, an optional emergency or 911 dialing feature of apparatus 302 permits the system (i.e., apparatus 302) to automatically dial an emergency telephone number (e.g., 911) if a user presses a particular button. One of buttons 312, for example, can be designated to implement such an emergency 911 dialing feature.

The caller ID phonebook feature can be implemented via an electronic phonebook/database connection through a serial port or computer (interface) card supporting 16, 32, 64, or 128 bit data to a personal computer and/or a USB connection. Apparatus 302 can also include a USB port 328. Data can be transferred to and from a personal computer to apparatus 302 utilizing USB port 328. Note that the acronym “USB” as utilized herein refers generally to the term “Universal Serial Bus,” which is a well-known standard for connecting peripheral devices, such as printers, scanners, digital cameras, modems, and so forth to computers. USB ports can be utilized in place of a variety of serial and parallel ports, for “low speed” and “medium speed” devices. USB is not as fast as SCSI (standard on all Macs), for connecting large external hard disks and other storage devices.

The wireless print system associated with apparatus 302 is a feature that permits apparatus 302 to be operated remotely utilizing an RJ11 or RJ45 connection. Apparatus 302 can include a memory unit that can permit storage of more than a thousand caller ID telephone numbers and addresses. The 900-telephone number blocking feature can also be initiated utilizing a particular button. For example, apparatus 302 features a button 342, which if pressed by a user, automatically blocks 900 telephone numbers. Circuitry and/or software associated with this feature can be integrated with apparatus 302. Additionally, utilizing a long distance code feature of apparatus 302, a user of apparatus 302 can set apparatus 302 to provide password protected long distance access for telephone numbers dialed from their telephone, which is connected with and/or in communication with apparatus 302.

Caller ID data can thus be retrieved from apparatus 302 by a personal computer and/or mobile devices stored in a memory location of the personal computer and/or mobile device. The caller ID data can then be processed via computer software, such as, for example, a computer database and/or spreadsheet software program. Caller ID data, including telephone numbers, time called and associated addresses thereof are stored at the personal computer/mobile device. Such a personal computer/mobile device, which is well known in the art, can also communicate with a portable computing device, such as, for example, a PDA (Personal Digital Assistant). Alternatively, apparatus 302 can communicate with a PDA via wireless means such as, for example, an IR (infrared) port 338. Thus, a PDA can “hot synch” or “synch” directly with apparatus 302 through wireless means, such as IR port 338. The terms “hot synch and “synch” are well known in the wireless communications and PDA arts.

A PDA is well known in the computing arts as a device for storing and maintaining information. Although a PDA may be connected to a desktop personal computer or another PDA via an infrared, direct wire, or wireless communication link, it can be appreciated that a PDA can be linked to a computer remote network, such as the Internet, or local wireless resources, such as RF broadcasts, through available wireless communications techniques. Examples of a PDA include the Palm Pilot™, Handspring Visor™, and Windows CE compatible hand held computers, such as the iPAQ™. Unlike personal computers, which are general-purpose devices geared toward refining and processing information, a PDA is designed to capture, store and display information originating from various sources. Additionally, while a certain level of skill is required to use a personal computer effectively, a PDA is designed with the novice and non-computer user in mind.

An example of a PDA, which can be utilized in accordance with the present invention described herein, is disclosed in U.S. Pat. No. 5,708,840, “Micro Personal Digital Assistant,” which issued on Jan. 13, 1998 to Kikinis et al, and which is incorporated herein by reference. Another example of a PDA, which can be utilized in accordance with the present invention described herein, is disclosed in U.S. Pat. No. 6,397,078, “Combined Mobile Telephone and Personal Digital Assistant,” which issued on May 28, 2002 to Young S. Kim. Of course, it can be appreciated by those skilled in the art that such devices should not be considered limiting features of the present invention. Instead, such PDA devices represent one of a variety of hand held devices, which can be utilized in accordance with the devices disclosed herein.

Apparatus 302 can additionally includes a speaker 334, which can permit apparatus 302 to function as a speaker telephone and/or a telephone answering machine. A user can record a message utilizing a microphone 336. Such a recorded message can be automatically played back for individuals who call the user's telephone number when the user is away or occupied with another telephone call. By pressing button 346, a user can also play a recorded message. Alternatively, by pressing button 348, a user can erase a recorded message.

The caller ID devices (i.e., apparatus 102, 202 and 302) disclosed herein can be configured according to a two-stage design process. Each apparatus 102, 202, 302 represent a caller ID data management apparatus that can also function as a home or business communications command center. There are two aspects to the caller ID apparatuses disclosed herein. The first aspect is based on the physical design of the casing itself, and the design of the programmable code content. The aim of such a design process is to offer a fast, easy to follow, interesting and effective manner for delivering caller ID data required to effect a successful operation thereof.

Information is normally communicated to a user via a rectangular-shaped LCD display, such as, for example, display screens 214 and 314, with increasingly intricate and complex graphics and sound. These two aspects can be harmoniously combined to create an interface that is appealing and user-friendly. The programming code implemented with such caller ID devices is generally easy to use and understand. It can hold the attention of the user, and can provide the service that a user desires and expects. The caller ID devices described herein can thus be designed in accordance with the individual application and the profile of a particular user.

Internally, a caller identification device such as apparatus 102, 202, or 302 can be configured to include a caller identification module. Such a caller identification module can be for example, a physical module such as particular hardware circuitry, which performs caller identification functions and/or a software module. Note that the term “module” as utilized herein can refer to either a physical module (e.g., circuitry) and/or software. An embodiment of the present invention can be implemented as a program product (i.e., computer program product) composed of one or more modules.

In the computer programming arts, a module can be implemented as a collection of routines and data structures that performs particular tasks or implements a particular abstract data type. Such modules (i.e., software modules) generally are composed of two parts. First, a software module may list the constants, data types, variable, routines, and so forth that can be accessed by other modules or routines. Second, a software module may be configured as an implementation, which can be private (i.e., accessible only to the module), and which contains the source code that actually implements the routines or subroutines upon which the module is based.

Thus, when referring to a “module” herein, the present inventors are referring so such software modules or implementations thereof. It can be appreciated by those skilled in the art the methodology illustrated herein can be implemented as a series of modules (i.e., software modules) which function alone or in combination with one or more physical modules. Such modules can be utilized separately or together to form a program product that can be implemented through signal-bearing media, including transmission media and recordable media. The present invention can thus be implemented as a program product composed of a plurality of such modules, which can be interactively displayed for a user on a display screen of a data-processing system, such as a personal computer and/or a caller ID device, such as apparatus 102, 202, or 302.

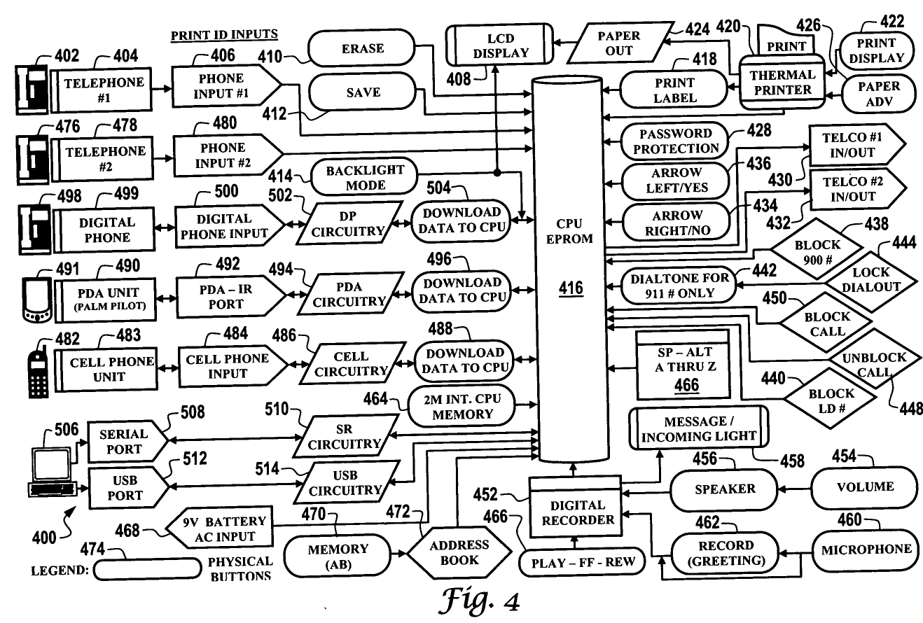

FIG. 4 depicts a high-level system diagram 400, for implementing a print caller ID apparatus, in accordance with a preferred embodiment of the present invention. Note that in FIG. 4, a legend 474 indicates actual physical input buttons, some of which may be integrated with the caller ID apparatus described herein, while others can be present on external devices, such as PDAs, cellular telephones, and so forth. A telephone 402 can thus communicate with a caller ID apparatus, such as apparatus 102, 202 or 302. Such a caller ID apparatus includes a combined memory/processor unit 416 (e.g., a CPU/EPROM), which can also include a database to which caller ID data can be stored and retrieved.

Memory/processor unit 416 can be integrated as a combined microprocessor and database or as separate microprocessor and database circuitry, which can communicate data with one another. The caller ID apparatus described herein can receive power via a power supply 568, which can be a combined 9V battery and/or AC input device. Memory/processor unit 416 can be connected to power supply 568 for operations thereof. Such a caller ID apparatus also includes a display screen 408, which can be, for example, an LCD display screen. Note that display screen 408 of FIG. 4 is analogous to display screen 214 of FIG. 2 and display screen 314 of FIG. 3. The caller ID apparatus can also include a printer 420, which can be implemented as a thermal printer. Output from printer 420 is illustrated at block 424.

The caller ID apparatus also can include a variety of input buttons, which operate in association and coordination with memory/processor unit 416. Input button 410 can function as an erase button, while input button 412 can function as a save button. Additionally, input button 414 can function as a backlight mode button. An input button 418 functions as a print label button, which when activated prints out via printer 420 a sheet of labels that can contain caller ID data such as telephone numbers, names, street addresses, time and date of call, and so forth. An input button 422, when activated by a user, can print out information currently shown on display screen 408. Input button 422 can be labeled “Print Display” or another similarly appropriate designation. An input button 426 can act as a printer advance button, which permits paper in printer 420 to advance for additional printing or removal thereof.

Additionally, Input buttons 434 and 426 can respectively function as “arrow right/no” and “arrow left/yes” buttons, while input button 428 can function as a password protection button, which when activated by a user initiates a password and/or user identification operation. Additionally, an input button 442 can automatically dial a 911 emergency telephone number when activated by a user, which can also result in a lock dial out operation, as depicted at block 444. Other input buttons that provide caller ID functionalities, in accordance with the apparatus described herein is an input button 470, which is labeled “Memory (AB)” and can provide address book capabilities, which permit a user to input and retrieve address information that can be associated with caller id information received by the unit 302.

A variety of electronic devices can communicate with memory/processor unit 416 and thus with a caller ID apparatus, such as apparatus 102, 202, or 302. For example, telephones 402 and 476 can communicate with the caller ID apparatuses described herein. Telephone 402 is generally labeled “Telephone #1” as indicated at block 404 and includes one or more telephone input buttons 406, which when activated can result in the display of data at display screen 408. Input buttons 406 thus permit the activation of particular caller ID apparatus functions. Similarly, telephone 476, which is generally labeled “Telephone #2” as indicated at block 478 can include one or more telephone input buttons 480, which provide user interactivity with memory/processor unit 416.

As indicated previously, the caller ID apparatus described herein also can communicate with a cellular telephone, such as cellular telephone 482, which is labeled “Cell Phone Unit” as indicated at block 491. Cellular telephone 482 can include a variety of cellular telephone input buttons 484 which provide user input, which is processed and controlled by cellular telephone circuitry, as illustrated at block 486. By activating one or more input buttons 484 of cellular telephone 482, data can be downloaded to and from cellular telephone 482 to memory/processor unit 416, as indicated at block 488, which is labeled, “Download Data to CPU.” Downloading can occur over a wireless communication link (e.g., IR or RF) with the caller id apparatus.

The caller ID apparatus described herein can additionally communicate with a Personal Digital Assistant (PDA) 491, which is labeled “PDA Unit” at block 490. PDA 491 can transmit data to and from memory/processor unit 416 through a PDA Infrared (IR) port, as indicated at block 492. PDA circuitry as indicated at block 494 permits data to be transferred to and from PDA 491 to memory/processor unit 416, as illustrated at block 496, which is labeled “Download Data to CPU.” Similarly, a digital telephone 498, which is labeled “Digital Phone” as depicted at block 499 can communicate with memory/processor unit 416 via one or more input buttons 500 of digital telephone 498, thereby permitting data to be transferred digital telephone 498 to and/or from memory/processor unit 416, as indicated by block 504, which is labeled “Download Data to CPU.” Digital telephone circuitry, as illustrated at block 502 can control the transfer of such data to and/or from memory/processor unit 416 to and/or from digital telephone 498.

The caller ID apparatus described herein can additionally communicate with a computer 508 either through a serial port as illustrated at block 508 or via a USB port as depicted at block 512. Serial port circuitry, which is labeled “SR Circuitry” at block 510 controls the transfer of data to and/or from memory/processor unit 416 to and/or from computer 508 through serial port depicted at block 508. Similarly, USB circuitry, which is labeled “USB circuitry” at block 514, can control the transfer of data to and/or from computer 508 to and/or from memory/process unit 416 through the USB port illustrated at block 512.

Caller ID apparatus disclosed herein can also be integrated with a digital recorder 452. The digital recorder 452 can communicate with memory/processor unit 416, a microphone 460 and a speaker 456. An input button 456 permits a user to record a greeting utilizing microphone 460, which is recorded by digital recorder 452. One or more input buttons 466 can provide forward, rewind and play capabilities. Playback can be activated utilizing input button 466, for example. Volume can be controlled utilizing an input button 454. Additionally, a message indicator in the form of a message light can be associated with digital recorder 452 in order to alert a user that a message is waiting for playback. Digital recorder 452 can record incoming telephone messages for later playback.

Processor/memory unit 416 can also be utilized to implement a number of other caller ID functionalities, such as, for example, blocking capabilities as indicated at blocks 448 and 450. Particular telephone numbers can be blocked or unblocked based on user-selected data, which is input by the user and processed via processor/memory unit 415. Particular area code 900 telephone numbers can also be blocked, as illustrated at block 438, along with the blocking of a particular LD telephone number as indicated at block 440. Input and output lines can also communicate with process/memory unit 416, as illustrated at blocks 430 and 432. Additionally, a variety of alphabetical input buttons A-Z can provide a means for inputting data to processor/memory unit 416. The processor/memory unit 416 can also communicate with an additional CPU/memory unit 464 for additionally processing and memory capabilities.

Based on the foregoing it can be appreciated that the present invention discloses an improved caller ID apparatus having integrated caller ID printing, management and storage capabilities. Such an apparatus can be implemented as a data management unit having a plurality of input buttons thereon, which permit a user to input commands to the data management unit, wherein the data management unit is connectable to a telephone, such as a standard consumer telephone, a cellular telephone and/or a digital telephone. The caller ID apparatus disclosed herein generally includes a caller identification module associated with the data management unit, wherein the caller identification module generates caller identification data based on caller identification data contained within a ring pattern of an incoming telephone call.

A printer unit can be integrated with said data management unit, wherein said printer unit prints caller identification data generated by said caller identification module. The caller ID apparatus disclosed herein additionally can include a display screen for displaying caller identification data generated by the caller identification module for a user. The printer unit can be configured as a thermal printer. The caller ID apparatus can also include a database for storing the caller identification data, wherein the database communicates with the data management unit for processing of the caller identification data for display via display screen and printing via the printer unit.

It can be appreciated by those skilled in the art that the invention disclosed herein can be modified accordance a variety of desired implementations. The embodiments and examples set forth herein are presented to best explain the present invention and its practical application and to thereby enable those skilled in the art to make and utilize the invention. Those skilled in the art, however, will recognize that the foregoing description and examples have been presented for the purpose of illustration and example only.

Other variations and modifications of the present invention will be apparent to those of skill in the art, and it is the intent of the appended claims that such variations and modifications be covered. The description as set forth is not intended to be exhaustive or to limit the scope of the invention. Many modifications and variations are possible in light of the above teaching without departing from the spirit and scope of the following claims. It is contemplated that the use of the present invention can involve components having different characteristics. It is intended that the scope of the present invention be defined by the claims appended hereto, giving full cognizance to equivalents in all respects.

The embodiments of the invention in which an exclusive property or right is claimed are defined as follows. Having thus described the invention

What is claimed is:

1. A caller identification data management apparatus, said apparatus comprising:
a data management unit having a plurality of input buttons thereon, which permit a user to input data and commands to said data management unit, wherein said data management unit is connectable to a telephone;
a caller identification module associated with said data management unit, wherein said caller identification module generates caller identification data based on caller identification data contained within a ring pattern of an incoming telephone call;
a printer unit integrated with said data management unit, wherein said printer unit prints at least one of the following:
a) caller identification data generated by said caller identification module;
b) address information associated with caller identification data; and
c) data entered into said data management; and
a display screen for displaying caller identification data generated by said caller identification module for a user.

2. The apparatus of claim 1 wherein said printer unit comprises a thermal printer.

3. The apparatus of claim 1 further comprising:
a database for storing said caller identification data, wherein said database communicates with said data management unit for processing of said caller identification data for display via display screen and printing via said printer unit.

4. The apparatus of claim 1 further comprising:
a PDA communications mechanism for communicating said caller identification data to and from a PDA to and from said data management unit.

5. The apparatus of claim 4 wherein said PDA communications mechanism comprises an infrared (IR) port integrated with said data management unit.

6. The apparatus of claim 1 further comprising:
a wireless telephone communications mechanism for communicating said caller identification data to and from a wireless telephone to and from said data management unit.

7. The apparatus of claim 1 further comprising:
a computer communications mechanism for communicating said caller identification data to and from a computer to and from said data management unit.

8. The apparatus of claim 7 wherein said computer communications mechanism comprises at least one USB port integrated with said data management unit.

9. The apparatus of claim 7 wherein said computer communications mechanism comprises at least one serial port integrated with said data management unit.

10. The apparatus of claim 1 wherein said data management unit comprises a processor for processing said caller identification data, such that said processor communicates with said database.

11. The apparatus of claim 1 further comprising:
a digital recorder, which communicates with said data management unit to record and play telephone messages;
a speaker associated with said digital recorder; and
a microphone associated with said digital recorder.

12. The apparatus of claim 1 wherein said display screen comprises back lighting.

13. The apparatus of claim 12 further comprising means for communicating with a mobile device.

14. A method for caller identification data management, said method comprising the steps of:
providing a data management unit having a plurality of input buttons thereon that permit a user to input commands and data into said data management unit, wherein said data management unit is connectable to a telephone;
associating a caller identification module with said data management unit, wherein said caller identification module generates caller identification data based on caller identification data contained within a ring pattern of an incoming telephone call;
integrating a printer unit with said data management unit, wherein said printer unit prints at least one of caller identification data generated by said caller identification module and data entered into said data management unit via said buttons; and
displaying caller identification data generated by said caller identification module for a user via a display screen integrated with said data management unit.

15. The method of claim 14 further comprising the step of:
providing a database for storing said caller identification data and data entered into said data management unit via said buttons, wherein said database communicates with said data management unit for processing of said caller identification data for display via display screen and for printing of at least one of said caller identification data generated by said caller identification module and data entered into said data management unit via said buttons via said printer unit.

16. The method of claim 14 further comprising the step of:
providing a processor for processing said caller identification data, such that said processor communicates with said database and wherein said processor is integrated with said data management unit.

17. The method of claim 1 further comprising the steps of:
configuring said data management unit with means to communicate with mobile devices wirelessly; and
enabling wireless communication between said data management unit and a mobile device.

18. A method for caller identification data management, said method comprising the steps of:
providing a data management unit having a plurality of input buttons thereon, which permit a user to input data and commands to said data management unit, wherein said data management unit is connectable to a telephone;
associating a caller identification module with said data management unit, wherein said caller identification module generates caller identification data based on caller identification data contained within a ring pattern of an incoming telephone call;
integrating a printer unit with said data management unit, wherein said printer unit prints caller identification data generated by said caller identification module and data entered into said data management unit via said input buttons, wherein said printer unit comprises a thermal printer;
displaying caller identification data generated by said caller identification module for a user via a display screen integrated with said data management unit;
providing a database for storing said caller identification data and data entered into said data management unit via said input buttons, wherein said database communicates with said data management unit for processing of said caller identification data for display via display screen and for printing caller identification data and/or data entered into said data management unit via said input buttons, wherein printing is via said printer unit; and
providing a processor for processing said caller identification data and said data entered into said data management unit via said input buttons, such that said processor communicates with said database and wherein said processor is integrated with said data management unit.

19. The method of claim 18 further comprising the steps of:
configuring said data management unit with means to communicate with mobile devices wirelessly; and
enabling wireless communication between said data management unit and a mobile device.

20. The method of claim 19 wherein said mobile device comprises a Personal Digital Assistant (PDA).
